(19) United States
(12) Patent Application Publication
(10) Pub. No.: US 2012/0325942 A1
(43) Pub. Date: Dec. 27, 2012

(54) JET MILLING OF BORON POWDER USING INERT GASES TO MEET PURITY REQUIREMENTS

(75) Inventors: James Michael Lustig, Mantua, OH (US); Jeffrey L. Johanning, Hudson, OH (US)

(73) Assignee: General Electric Company, Schenectady, NY (US)

(21) Appl. No.: 13/169,103

(22) Filed: Jun. 27, 2011

(51) Int. Cl. B02C 19/06

(52) U.S. Cl. 241/5; 241/39

(57) ABSTRACT

A processing system and associated method for milling boron with impurity contamination avoidance. The system includes a jet mill for reducing the particle size of a boron feed stock, and a feed stock inlet for delivering the boron feed stock toward the jet mill. The system includes at least one inlet for delivering at least one gas into the jet mill. The gas and the boron feed stock comingle within the jet mill during milling reduction of boron particle size. The system includes a source of the at least one gas operatively connected to the at least one inlet, with the at least one gas being a gas that avoids transferring impurity during milling reduction of boron particle size.

### BACKGROUND OF THE INVENTION

1. Field of the Invention

The subject matter disclosed herein relates to jet milling boron powder, and more particularly to jet milling of boron powder using inert gases to meet purity requirements.

2. Discussion of the Prior Art

Jet mills are used for pulverizing feed stock materials with relatively large particle sizes into powders with relatively small particle sizes. Often, jet mills are operated with compressed air obtained from the ambient atmosphere of the shop wherein the compressed air is used as a carrier to suspend the particles in a fluid flow within the jet mill. However, the compressed air may include some oil content. Such oil content may be introduced into the compressed air from a variety of sources. For example, the moving compressor component may have oil located thereon and the oil may comingle with the air being compressed. When the compressed air is used as a feed gas, milling gas, or both, to operate the jet mill, the oil included in the compressed air is often imparted to the final product of the jet milling operation. Impurities such as oil can foul the final product such as a milled boron powder that is extracted from the jet mill. As a result, the milled boron powder may be either unusable, or may have to undergo further processing to remove the impurities prior to using the powder in a manufacturing process. Thus, there is a need for improvements in the methods and equipment employed to jet mill boron feed stock.

### BRIEF DESCRIPTION OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect, the present invention provides a processing system for milling boron with impurity contamination avoidance. The processing system includes a jet mill for reducing the particle size of a boron feed stock. The system includes a feed stock inlet for delivering the boron feed stock toward the jet mill. The system includes at least one inlet for delivering at least one gas into the jet mill. The gas and the boron feed stock comingle within the jet mill during milling reduction of boron particle size. The system includes a source of the at least one gas operatively connected to the at least one inlet. The at least one gas is a gas that avoids transferring impurity during milling reduction of boron particle size.

In accordance with another aspect, the present invention provides a method of milling boron with impurity contamination avoidance. The method includes providing a jet mill for reducing the particle size of a boron feed stock. A feed stock inlet is provided for delivering the boron feed stock toward the jet mill. At least one inlet is provided for delivering at least one gas into the jet mill. The gas and the boron feed stock are comingled within the jet mill during milling reduction of boron particle size. A source of the at least one gas is provided and operatively connected to the at least one inlet. The at least one gas is a gas that avoids transferring impurity during milling reduction of boron particle size.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 is a schematized plan view of an example jet mill of an example processing system in accordance with an aspect of the present invention;

FIG. 2 is a cross-sectional view of the example processing system of FIG. 1 showing cross section A-A in FIG. 1 through the upper portion of the processing system and cross section B-B in FIG. 1 through the lower portion of the processing system, and also shows gas supplies of the example system; and

FIG. 3 is a top level flow diagram of an example method of milling boron feed stock in a jet mill in accordance with an aspect of the present invention.

### DETAILED DESCRIPTION OF THE INVENTION

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices. Moreover, certain terminology is used herein for convenience only and is not to be taken as a limitation on the present invention. Still further, in the drawings, the same reference numerals are employed for designating the same elements.

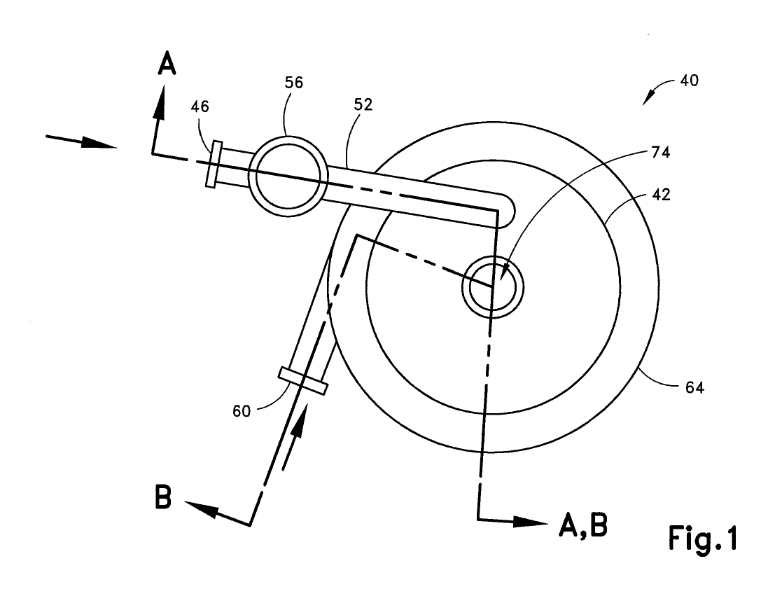

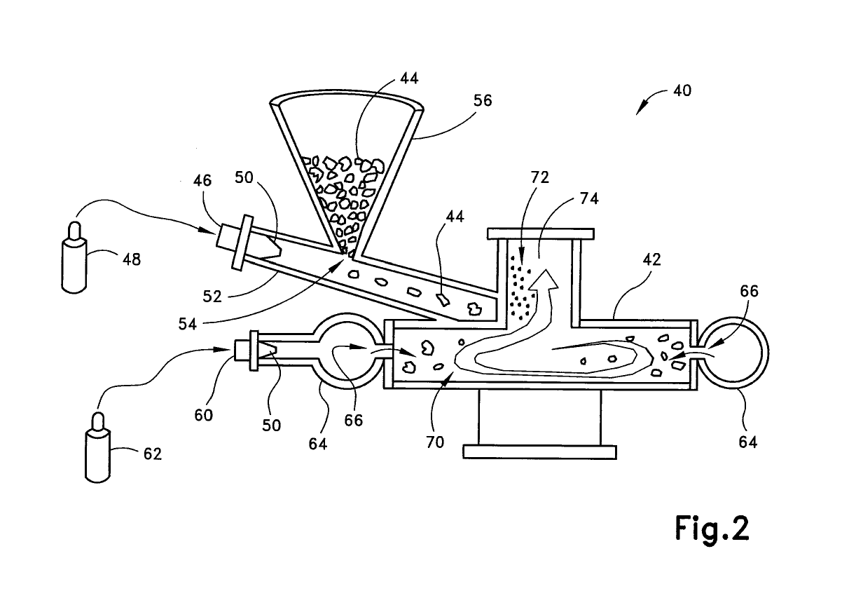

An example processing system 40 that includes a jet mill 42 is generally shown within FIGS. 1 and 2. In one specific example, the processing system 40 is for production of milled boron powder. It is to be appreciated that other powders could be milled. The processing system 40 makes use of at least one inert gas in accordance with an aspect of the present invention as will be described in following detail.

It is to be appreciated that FIGS. 1 and 2 show one example of possible structures/configurations/etc. and that other examples are contemplated within the scope of the present invention. It should be noted that FIG. 1 indicates compound cross section locations used to provide the section view of FIG. 2 (i.e., different portions are sectioned along different, respective section lines). Specifically, the cross section shown in FIG. 2 is a combination of the cross section A-A (FIG. 1) is through the upper portion of the processing system 40 and cross section B-B (FIG. 1) is through the lower portion of the processing system.

The jet mill 42 is for reducing the particle size of a boron feed stock 44. The shown example jet mill 42 is a vortex-type jet mill. However, the jet mill can be another type such as, but not limited to, and a fluidized bed jet mill. It is to be appreciated that the boron feed stock 44 shown in FIG. 2 is for illustration purposes only and does not represent actual particle sizes or scale sizes and thus should not be used for relative dimensioning. The boron feed stock 44 can include particles of various sizes and may be identified by particular “mesh” or “screen” particle size(s). Also, the born feed stock may include B-10 boron such that the B-10 is at least 98% by weight.

The processing system 40 can also include a first gas inlet 46 for delivering a feed gas 48 (schematically represented by a bottle-type source example) into the jet mill 42. The first gas inlet 46 can include a nozzle 50 to direct the flow of the feed gas 48 into the jet mill 42 and accelerate the feed gas 48. Thus, a feed gas inlet stream is created that proceeds into the jet mill 42. An inlet tube 52 can be used to deliver the feed gas 48 from the first gas inlet 46 to the jet mill 42. The inlet tube 52 can be attached to the jet mill 42 tangentially to the circumference of the jet mill 42 (best shown in FIG. 2). It is to be appreciated that the connection between the source of the feed gas 48 and the first gas inlet 46 can be secured so that little or no ambient atmosphere can enter into the jet mill 42 with the feed gas 48. Also, it is to be appreciated that the connection between the source of the feed gas 48 and the first gas inlet 46 can be secured so that little or no feed gas 48 is lost to the ambient atmosphere.

The processing system 40 further includes a feed stock inlet 54 for delivering the boron feed stock 44 into the feed gas inlet stream of feed gas 48 so that the feed stock 44 is comingled with the feed gas 48 and proceeds with the feed gas 48 into the jet mill 42. The feed stock inlet 54 can be provided as an aperture in the inlet tube 52 that enables boron feed stock 44 to enter the stream of feed gas that is flowing past the aperture. A boron feed stock hopper 56 (e.g., a funnel shape or similar device) that contains the boron feed stock 44 is attached to the inlet tube 52 to supply the boron feed stock 44 at the inlet 54. It is to be appreciated that the feed stock hopper 56 (or similar device) can be secured/sealed so that little or no ambient atmosphere can enter into the jet mill 42 with the feed stock 44.

A second gas inlet 60 is also included in the processing system 40 for delivering a milling gas 62 (schematically represented by a bottle-type source example) into the jet mill 42. The second gas inlet 60 can be provided with a nozzle 50 to direct the flow of the milling gas 62 and accelerate the milling gas 62. It is to be appreciated that the connection between the source of the milling gas 62 and the second gas inlet 60 can be secured so that little or no ambient atmosphere can enter into the jet mill 42 with the milling gas 62. Also, it is to be appreciated that the connection between the source of the milling gas 62 and the second gas inlet 60 can be secured so that little or no milling gas 62 is lost to the ambient atmosphere.

The milling gas 62 can be directed into the jet mill 42 with the use of a toroidal manifold 64 encircling the exterior of the jet mill 42. The toroidal manifold 64 imparts directional movement of the milling gas 62 to flow around the entire circumference of the jet mill 42. The milling gas 62 proceeds from the toroidal manifold 64 to the jet mill 42 via a plurality of apertures 66 distributed along the toroidal manifold 64. The apertures 66 are designed to direct the flow of the milling gas 62 into the jet mill 42 in a substantially tangential direction to the circumference of the jet mill 42.

The jet mill 42 of the processing system 40 also includes a milling chamber 70. The milling chamber 70 can be a vortex type milling chamber as is known in the art. The milling chamber 70 can be of a cylindrical shape having a diameter that is several times larger than its height. The feed gas 48 and its entrained boron feed stock 44 enter the milling chamber 70 of the jet mill 42 in a direction tangential to the circumference of the milling chamber 70. The milling gas 62 is also introduced into the milling chamber 70 in a substantially tangential direction to the circumference of the milling chamber 70. The flow direction of the feed gas 48 and the milling gas 62 create a vortex flow path in the milling chamber 70. Thus, the feed stock 44 and the gases (feed gas 48 and the milling gas 62) are comingling within the milling chamber 70 of the jet mill 42.

The feed gas 48 and the milling gas 62 impart high velocity and energy to the entrained boron feed stock 44, forcing the boron feed stock 44 particles into high-speed collisions as they travel around the vortex inside the milling chamber 70. These high-speed collisions between particles and collisions between particles and the milling chamber 70 walls break down the boron feed stock 44 into smaller and smaller particles. Centrifugal force tends to maintain the larger boron feed stock 44 particles closer to the circumference of the milling chamber 70. As the boron feed stock 44 particles get smaller and smaller, they are able to move closer to the center of the milling chamber, all the while being bombarded by other boron particles. In other words, as the boron feed stock 44 particles are milled into smaller and smaller sizes, they have less mass that would force them toward the outer circumference of the milling chamber. Eventually, the boron feed stock particles are ground into a milled boron powder 72 consisting of the desired particle size. The resultant particle size can be controlled via several operating parameters including the flow rate and pressure of the feed gas 48 and the milling gas 62, nozzle 50 geometry, milling chamber 70 geometry, and the feed rate of the boron feed stock 44. The processing system 40 can be used when jet milling boron feed stock 44 particles to a size in the range of one micron, although other particle size ranges are also contemplated.

The processing system 40 further includes an outlet 74 from the milling chamber 70 for discharge of a milled boron powder 72. The feed gas 48 and the milling gas 62 are also exhausted out from the outlet 74. The smaller particles which are now considered to be the milled boron powder 72 eventually make their way to the center of the milling chamber and are carried through the outlet by 74 via the exiting/exhausting feed gas 48 and milling gas 62. The shown example provides the outlet 74 at a location at the top of the milling chamber 70, in a coaxial position with the milling chamber 70. After passing through the outlet 74, the milled boron powder 72 can be easily collected/captured and classified according to particle size. Additionally, the feed gas 48 and the milling gas 62 flowing through the outlet may be collected/captured and recycled, or it may be vented to ambient atmosphere.

The described processing system 40 can provide a milled boron powder 72 that contain a relatively little or no amount of impurities in accordance with an aspect of the present invention. This aspect occurs despite the comingling of the boron 44, 72 and the gases 48, 62 during milling. Such minimized impurity amount is in comparison to milling that is done using compressed air that contains an oil as an example contaminate impurity. The inventive aspect of providing a milled boron powder 72 that contains a relatively little or no amount of impurities is accomplished by selecting an appropriate feed gas 48 and/or milling gas 62 for the processing system 40. One basis for selection of the feed gas 48 and/or the milling gas 62 is the lack of impurities within the gas which could be transferred to the boron feed stock 44/milled boron powder 72 during the milling. Thus, milling the boron feed stock 44 into a milled boron powder 72 such that the resulting milled boron powder 72 contains a reduced amount of impurities is a direct result of choosing a feed gas 48 and/or a milling gas 62 (which may be the same gas) to impart few, if any, impurities to the boron feed stock 44.

In one example, nitrogen is chosen for the feed gas 48 and/or the milling gas 62. Thus, nitrogen is used instead of a gas, such as compressed air, that contains higher levels of impurities. As mentioned, previous/known mills often use compressed air for the feed gas and milling gas, and as a result, certain jet mill operating parameters are set for the use of compressed air. The viscosity and general behavior of nitrogen gas is similar to that of air, thus resulting in fewer required changes to the operating parameters of the jet mill 42. The supply of nitrogen (schematically represented by bottle-type sources in FIG. 2) may be any suitable device that supplies nitrogen. For example, the supply may include a container of liquid nitrogen with a vaporizer to gasify the liquid nitrogen or a container of compressed nitrogen gas. It should be noted that if both the feed gas 48 and the milling gas 62 are nitrogen, the schematically represented bottle-type sources in FIG. 2 could be combined to be a single source.

Additionally, the industrial purification process for nitrogen eliminates a large percentage of the impurities in the gas. When used as a replacement for compressed air at an industrial location, nitrogen does not impart a significant amount of impurities to the boron feed stock 44 or the milled boron powder 72. The use of nitrogen as a feed gas 48 and a milling gas 62 enables production of a milled boron powder 72 with a reduced amount of impurities at less than about 0.1 weight percent of soluble residue. This level of impurity can be considered to be an acceptable level of soluble residue that does not affect a hydrophilic nature of the milled boron powder 72.

While being mindful of the jet mill 42 operating parameters, other examples can be based upon utilization of other gases. For example, other inert gases could be used as the feed gas 48 and/or the milling gas 62. As specific examples, noble gases could be used as the feed gas 48 and/or the milling gas 62. One specific noble gas example is argon. The supplies of inert/noble gas(es) (schematically represented by bottle-type sources in FIG. 2) may be any suitable device(s) that supply the inert/noble gas(es). The noble gases are chemically inert to the boron.

As yet another example, steam can be used as the feed gas 48 and/or the milling gas 62 to reduce the impurities as compared to ordinary compressed air. Such steam could be generated by boiling a source of liquid water. Thus, the supply of steam (schematically represented by bottle-type sources in FIG. 2) may be any suitable device(s) that supply the steam. Steam does not chemically affect the boron and thus can be considered to be chemically inert for this process.

The method of jet milling of boron feed stock 44 using inert gases to meet purity requirements and the associated process system is one solution to reduce impurities from a milled boron powder 72. Additionally, the replacement of standard shop compressed air with nitrogen gas is a low-cost alternative to other purified gases when reducing the impurities found within a milled boron powder 72. The properties of nitrogen gas are similar to those of compressed air, leading to fewer operating parameter changes for the jet milling procedure. Furthermore, the use of nitrogen as a feed gas 48 and a milling gas 62 reduces the likelihood of oxidation of the ground feed stock.

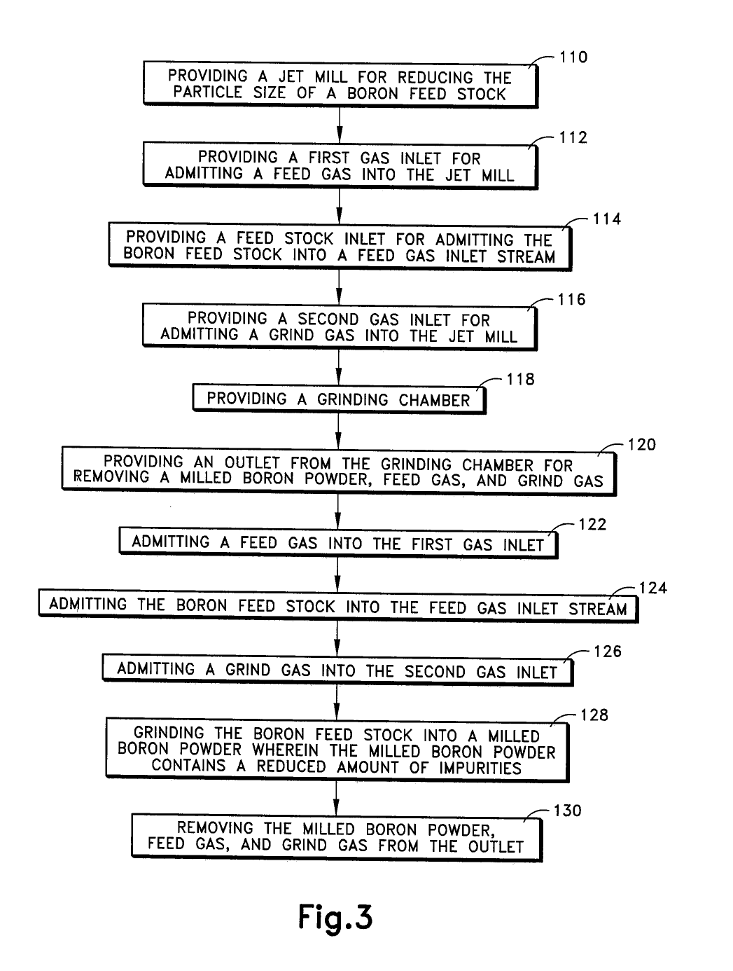

An example method of jet milling boron powder using inert gases to meet purity requirements is generally described in FIG. 3. The method can be performed in connection with the example jet mill shown in FIGS. 1 and 2. The method includes the step 110 of providing a jet mill for reducing the particle size of boron feed stock. The boron feed stock can include particles of various sizes and may be identified by particular “mesh” or “screen” sizes. The jet mill can be any number of types that are known in the art including, but not limited to, vortex-type jet mills and fluidized bed jet mills.

The method includes the step 112 of providing a first gas inlet for admitting a feed gas into the jet mill. The first gas inlet can include a nozzle to direct the flow of the feed gas into the jet mill and accelerate the feed gas. An inlet tube can be used to deliver the feed gas from the first gas inlet to the jet mill.

The method includes the step 114 of providing a feed stock inlet for admitting the boron feed stock into a feed gas inlet stream. The feed stock inlet can include an aperture in the inlet tube that enables boron feed stock to enter the stream of feed gas that is flowing past the aperture. A boron feed stock funnel, hopper, or similar device that contains the boron feed stock can be attached to the inlet tube.

The method further includes step 116 of providing a second gas inlet for admitting a milling gas into the jet mill. The second gas inlet can be provided with a nozzle to direct the flow of the milling gas into the toroidal manifold and accelerate the milling gas.

The method also includes the step 118 of providing a milling chamber. The milling chamber can be a vortex type milling chamber as is known in the art. The milling chamber can be of a cylindrical shape having a diameter that is several times larger than its height.

The method further includes the step 120 of providing an outlet from the milling chamber for removing a milled boron powder, the feed gas, and the milling gas. The outlet can be located on the top wall of the milling chamber sharing a central axis with the milling chamber.

The method still further includes the step 122 of admitting a feed gas into the first gas inlet. The feed gas is supplied at a sufficient pressure and volume to operate the jet mill. A nozzle is typically used to direct the feed gas, accelerate the feed gas, and create a smooth feed gas stream as it enters the jet mill

The method also includes the step 124 of admitting the boron feed stock into the feed gas inlet stream. Boron feed stock becomes entrained in the feed gas inlet stream as it moves past the feed stock inlet. The feed gas inlet stream then delivers the boron feed stock to the milling chamber in a tangential direction to the cylindrical body of the milling chamber.

The method further includes the step 126 of admitting a milling gas into the second gas inlet. A vortex jet mill can include a toroidal manifold around its circumference. The toroidal manifold can include apertures designed to direct the milling gas into the milling chamber in a tangential direction to the cylindrical body of the milling chamber, thus creating a vortex flow path within the milling chamber.

The method still further includes the step 128 of milling the boron feed stock into a milled boron powder wherein the milled boron powder contains a reduced amount of impurities. The feed gas and the milling gas impart high velocity and energy to the entrained boron feed stock, forcing the boron feed stock particles into high-speed collisions as they travel around the vortex inside the milling chamber. These high-speed collisions break down the boron feed stock into smaller and smaller particles. Centrifugal force tends to maintain the larger boron feed stock particles closer to the circumference of the milling chamber. As the boron feed stock particles get smaller and smaller, they are able to move closer to the center of the milling chamber, all the while being bombarded by other boron particles. Eventually, the boron feed stock particles are ground into a boron powder consisting of the desired particle size.

The method also includes the step 130 of removing the milled boron powder, feed gas, and milling gas from the outlet. As the boron feed stock particles are ground into smaller and smaller sizes, they have less mass that would force them toward the circumference of the milling chamber. The smaller particles eventually make their way to the center of the milling chamber and are carried through the outlet by the feed gas and milling gas as they exit the milling chamber through the outlet.

In one example of the method, nitrogen is chosen for the feed gas and/or the milling gas. Thus, nitrogen is used instead of a gas, such as compressed air, that contains higher levels of impurities. As mentioned, previous/known mills often have used compressed air for the feed gas and milling gas, and as a result, certain jet mill operating parameters are set for the use of compressed air. The viscosity and general behavior of nitrogen gas is similar to that of air, thus resulting in fewer required changes to the operating parameters of the jet mill. Also, when used as a replacement for compressed air, nitrogen does not impart a significant amount of impurities to the boron. The use of nitrogen as a feed gas and a milling gas enables production of a milled boron powder with a reduced amount of impurities at less than about 0.1 weight percent of soluble residue. This level of impurity can be considered to be an acceptable level of soluble residue that does not affect a hydrophilic nature of the milled boron powder.

Other examples can be based upon utilization of other gases. For example, other inert gases could be used as the feed gas and/or the milling gas. As specific examples, noble gases could be used as the feed gas and/or the milling gas. One specific noble gas example is argon. As yet another example, steam can be used as the feed gas and/or the milling gas to reduce the impurities as compared to ordinary compressed air. Steam does not chemically affect the boron and thus can be considered to be chemically inert for this process.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A processing system for milling boron with impurity contamination avoidance, the processing system including:
a jet mill for reducing the particle size of a boron feed stock;
a feed stock inlet for delivering the boron feed stock toward the jet mill;
at least one inlet for delivering at least one gas into the jet mill, the gas and the boron feed stock comingling within the jet mill during milling reduction of boron particle size; and
a source of the at least one gas operatively connected to the at least one inlet, with the at least one gas being a gas that avoids transferring impurity during milling reduction of boron particle size.

2. The processing system according to claim 1, wherein the at least one gas is an inert gas.

3. The processing system according to claim 3, wherein the at least one gas is nitrogen.

4. The processing system according to claim 1, wherein the at least one gas is a noble gas.

5. The processing system according to claim 4, wherein the at least one gas is argon.

6. The processing system according to claim 1, wherein the at least one gas is steam.

7. The processing system according to claim 1, wherein an amount of impurities in the milled boron powder is not more than about 0.1 weight percent of soluble residue.

8. The processing system according to claim 1, wherein the at least one inlet for delivering the at least one gas into the jet mill includes a feed gas inlet, wherein the feed gas moves the boron feed stock.

9. The processing system according to claim 1, wherein the at least one inlet for delivering the at least one gas into the jet mill includes a milling gas inlet.

10. The processing system according to claim 1, wherein the boron feed stock includes at least 98% by weight B-10 boron.

11. A method of milling boron with impurity contamination avoidance, the method including:
providing a jet mill for reducing the particle size of a boron feed stock;
providing a feed stock inlet for delivering the boron feed stock toward the jet mill;
providing at least one inlet for delivering at least one gas into the jet mill;
comingling the gas and the boron feed stock within the jet mill during milling reduction of boron particle size; and
providing a source of the at least one gas operatively connected to the at least one inlet, with the at least one gas being a gas that avoids transferring impurity during milling reduction of boron particle size.

12. The method according to claim 11, wherein the at least one gas is an inert gas.

13. The method according to claim 12, wherein the at least one gas is nitrogen.

14. The method according to claim 11, wherein the at least one gas is a noble gas.

15. The method according to claim 14, wherein the at least one gas is argon.

16. The method according to claim 11, wherein the at least one gas is steam.

17. The method according to claim 11, wherein an amount of impurities in the milled boron powder is not more than about 0.1 weight percent of soluble residue.

18. The method according to claim 11, wherein the at least one inlet for delivering the at least one gas into the jet mill includes a feed gas inlet, wherein the feed gas moves the boron feed stock.

19. The method according to claim 11, wherein the at least one inlet for delivering the at least one gas into the jet mill includes a milling gas inlet.

20. The processing system according to claim 11, wherein the boron feed stock includes at least 98% by weight B-10 boron.
